(19) United States
(12) Patent Application Publication
(10) Pub. No.: US 2022/0326930 A1
(43) Pub. Date: Oct. 13, 2022

(54) UPDATED PACKAGES HOSTED BY ON-PREMISE GATEWAYS MANAGING AS-A-SERVICE WORKLOADS

(71) Applicant: Hewlett Packard Enterprise Development LP, Houston, TX (US)

(72) Inventors: Divakar Padiyar Nandavar, Bangalore Karnatatka (IN); Sonu Sudhakaran, Bangalore Karnataka (IN); Pradeep Sathasivam, Bangalore Karnataka (IN); Kalpana Kandhamaran, Bangalore Karnataka (IN)

(21) Appl. No.: 17/301,629

(22) Filed: Apr. 9, 2021

(51) Int. Cl. G06F 8/65; G06F 8/71; H04L 29/08

(52) U.S. Cl. CPC G06F 8/65; G06F 8/71; H04L 67/34

(57) ABSTRACT

Examples described relate to configuration management systems and updates to packages hosted on an on-premise gateway. In an example, availability of an updated version of a package for each tenant among a plurality of tenants subscribing to the package is determined. The updated version corresponds to a change to at least one of a plurality of service components included in the package. The determination is based on a latest version information of the package, an installed version information of the package for the tenant, and an environment information stored in a plurality of repositories. Each of the plurality of repositories is identified by a repository name indicative of the package and the environment information. The updated version of the package is published for the tenant to be installed on the on-premise gateway and a notification indicative of availability of the updated version is sent to the on-premise gateway.

### BACKGROUND

Data may be stored on a private on-premise network (also referred to as a private cloud) or on a public cloud network, either having computing nodes, such as a server, a storage array, a cluster of servers, a computer appliance, a workstation, a storage system, a converged system, a hyperconverged system, or the like. In some examples, the data stored on the private on-premise network or on the public cloud network may be accessed via cloud-based web-portals.

### BRIEF DESCRIPTION OF THE DRAWINGS

These and other features, aspects, and advantages of the present specification will become better understood when the following detailed description is read with reference to the accompanying drawings in which like characters represent like parts throughout the drawings, wherein:

FIG. 1 depicts a networked system including a private on-premise gateway and a configuration management system, in accordance with an example;

FIG. 2 depicts operations for maintaining versioning of service components in a repository, in accordance with an example;

FIG. 3 depicts a networked system for updating a package hosted on an on-premise gateway for managing as service workloads, in accordance with an example;

FIG. 4 depicts a configuration management system hosted in a Software as a Service (SaaS) cloud platform, in accordance with an example;

FIG. 5 is a flow diagram depicting a method for managing updates to a package hosted on an on-premise gateway for managing as service workloads, in accordance with an example;

FIG. 6 is a flow diagram depicting a method for managing updates to a package hosted on an on-premise gateway for managing as service workloads, in accordance with an example; and

FIG. 7 is a block diagram depicting a processing resource and a machine-readable medium encoded with example instructions to facilitate update of packages hosted in an on-premise gateway for managing as-a-service workloads, in accordance with an example.

It is emphasized that, in the drawings, various features are not drawn to scale. In fact, in the drawings, the dimensions of the various features have been arbitrarily increased or reduced for clarity of discussion.

### DETAILED DESCRIPTION

Data may be stored on a private on-premise network or on a public cloud network having computing nodes, such as a server, a storage array, a cluster of servers, a computer appliance, a workstation, a storage system, a converged system, a hyperconverged system, or the like. The term on-premise may be understood to mean, for example, on location at premises (e.g., real estate, such as a data center) owned or operated by a user or organization or at a colocation center rented to the user or organization. In some examples, the data stored on the private on-premise network or on the public cloud network may be accessed via cloud-based web-platforms. The cloud-based web-platforms may be implemented as a software-as-a-service (SaaS) cloud platform. In some examples, the private on-premise network may include a private on-premise gateway (also referred to as an on-premise gateway) for managing as-a-service workloads. The on-premise gateway may provide IT infrastructure situated on the premises, datacenters, or colocation centers of the customers and have the capability of interacting with the SaaS cloud platform. In some examples, certain cloud-based portals may provide users a cloud-like experience by allowing management and/or usage of capabilities such as, for example, IT infrastructure and/or services offered by the on-premise gateway, in a pay-per-use model. The cloud-based portal may allow tenant to access workloads managed by the on-premise gateway in the pay-per-use model. A tenant may be a group of users that share access or subscription privileges to given workload(s), and different organizations may be different tenants, and an organization may further include multiple tenants within.

In some examples, the on-premise gateway may host packages for providing different services, such as services that provide infrastructure as a service (IaaS), platform as a service (PaaS), and software as a service (SaaS). A package may include a bundle of software, firmware, hardware, or a combination thereof hosted in the on-premise gateway and accessible via the SaaS cloud platform. The packages may provide a collection of functionalities and/or capabilities, such as Virtual Machine (VM) hosting and maintenance, providing containerized application services, IT infrastructure services, etc., which may be implemented at the on-premise gateway and accessed via the SaaS cloud platform. The packages may provide several functionalities associated with building, managing, and operating the on-premise gateway.

The packages hosted on the on-premise gateway may be managed by different service teams. The service teams may release patches, bugfixes, hotfixes, new versions, etc., associated with the packages as part of their release cycles. The service teams may release changes to service components included in a package. A service component may be a virtualized or a containerized service and may include source code, dependencies, sub-components, etc. which provides capabilities to a package to perform its operations. A change to a service component may include a change in a service sub-component included within the service component. For multiple packages hosted on the on-premise gateway having multiple service components, different service teams may issue one or more than one change.

Typically, developers in the service teams submit their change to a central database. The change is then validated and merged with the service component/sub-component included in the package. After validation, an updated version of the package is released for consumption. Because the package is subscribed to by different tenants at different locations, the updated version of the package may be deployed at different on-premise gateways accessible by the tenants subscribing to the package. Thus, the updated version of the package is to be consumed by multiple on-premise gateways. Also, the updated version may be at different stages of development. Further, different tenants subscribing to a package may selectively subscribe to one or more service components in the package, and hence, an update to a service component may be selectively deployed in the on-premise gateways depending on tenant-specific configurations. Thus, different additions, alterations, and modifications to the packages may be issued by different service teams at different stages of development at different times depending on their release cycles. Therefore, providing automated/zero touch update mechanisms for updating the changes in the service components and packages may be challenging.

Further, with DevOps based mechanisms for releasing and delivering updates, continuous integration (CI) of different service components included in different packages hosted in an on-premise gateway and continuous delivery (CD) of the same is complex for multiple tenants with varying tenant specific requirements. Further, lack of standard mechanisms of maintaining version information of the packages and its components and sub-components increases challenges in implementing automated updates for the packages. The challenges described above are further exacerbated as the numbers of tenants increase and as the number of services offered via the on-premise gateway increase.

Therefore, in accordance with the aspects of the present disclosure, a configuration management system is presented that may facilitate automatic updates to provide a release and update management mechanism that enables CI/CD for service components and packages. Also, the release and update management mechanism of the present disclosure may enable efficient service versioning, release bundling and deployment strategy for delivering the updates to the packages. Further, the release and update management mechanism of the present disclosure may provide agility to the service teams to develop, test, and release their service components independently yet with the flexibility to collaborate with other service teams.

In an example, the configuration management system determines availability of an updated version of a package for each tenant among a plurality of tenants subscribing to the package. The package may include a plurality of service components, where the package is among a plurality of packages hosted on an on-premise gateway for managing as-a-service workloads. A service component may provide a service functionality to the package and may be mapped to one or more packages. The updated version of the package corresponds to a change to at least one of the plurality of service components, where the change is received from (or in other words, originates from) at least one of a plurality of different service teams managing the plurality of service components. In an example, the availability is determined based on a latest version information of the package, an installed version information of the package for the tenant, and an environment information. The latest version information indicates a new version of a package or service component that is released and available for consumption. The installed version information indicates a version of a package or service component that is deployed and running in an on-premise gateway. The environment information indicates a development stage of the package or service component, where the development stage may be integration, staging, or deployment. The latest version information, installed version information, and environment information may be stored in a plurality of repositories. Each of the plurality of repositories may be identified by a repository name indicative of the package and the environment information. In response to determining that the updated version of the package is available, the configuration management system may publish the updated version of the package for the tenant to be installed on the on-premise gateway. Further, the configuration management system sends a notification indicative of availability of the updated version to the on-premise gateway.

As will be appreciated, the configuration management system provides an update management mechanism by using version information and information related to development stage, identifying availability of the updated version of the package for each tenant based on their requirements, and providing notification to apply the available updates. Advantageously, this update management mechanism may be implemented without altering the on-premise packages. Additionally, the configuration management system described herein may implement standard techniques of version information management which may be efficiently leveraged for integration and delivery of updates for packages which may be included in the on-premise gateways in the future. Thus, the update management mechanisms of the present disclosure may be extensible and forward-compatible with future packages offering IaaS, PaaS, or SaaS services.

The following detailed description refers to the accompanying drawings. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

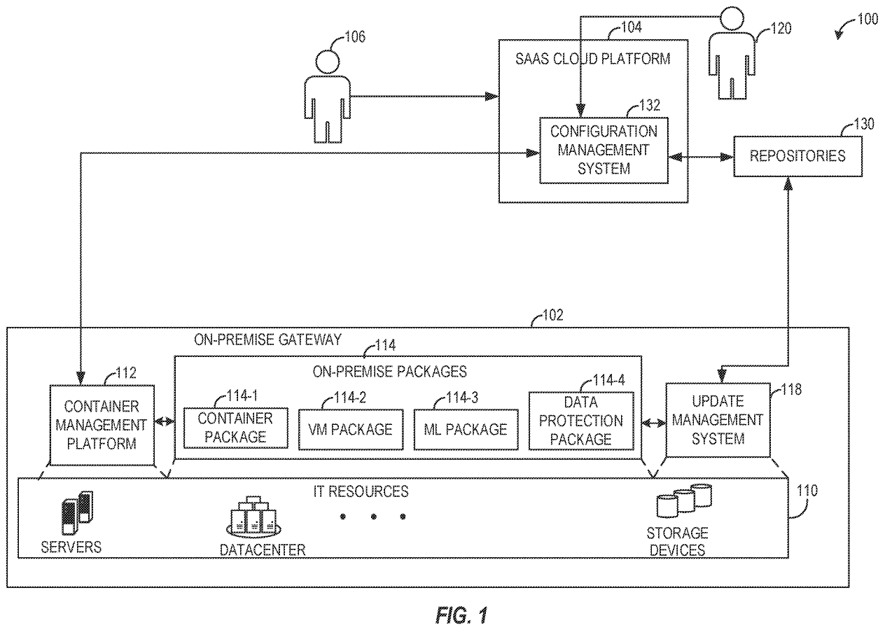

Referring now to the drawings, in FIG. 1, a networked system 100 is presented, in accordance with an example. As depicted in FIG. 1, in some examples, the networked system 100 may include an on-premise gateway 102 and a software-as-a-service (SaaS) cloud platform 104. The SaaS cloud platform 104 may provide tenants (e.g., including a user 106 of a tenant) of the SaaS cloud platform 104 a cloud-like experience by allowing management and/or usage of capabilities such as, for example, information technology (IT) infrastructure and/or services offered by the on-premise gateway 102 in a pay-per-use model. The user 106 may access the SaaS cloud platform 104 on any device including but not limited to a personal computer, a portable or handheld computing device (e.g., a laptop, a smartphone, personal digital assistant, and the like), via a web browser (e.g., in the form of a web portal) or an integrated application. Depending on a subscription held by the user 106 (or by the tenant of the user), the user 106 may be able to access some of all capabilities offered by the SaaS cloud platform 104.

As depicted in FIG. 1, the networked system 100 may also include repositories 130 to facilitate version and configuration management of on-premise packages hosted in the on-premise gateway. In some examples, the repositories 130 may be managed by an independent third-party organization or an organization managing the SaaS cloud platform 104. The repositories may store and maintain version information associated with developed, released, and deployed versions of different service components included in different on-premise packages for different tenant locations. The repositories 130 provide a storage location for software packages along with metadata. The repositories 130 are typically managed by source control or repository managers. Developers of a package may update the repository with the latest versions of the service components.

The SaaS cloud platform 104 includes a configuration management system 132 which controls version management operations for on premises packages. The configuration management system 132 also interfaces with the repositories 130 to update different versions of the service components in the repositories and deploy updated version in the on-premise packages.

The on-premise gateway 102 may include a network of IT resources 110 hosted within premises of a tenant. Although a single on-premise gateway 102 is shown in FIG. 1, the networked system 100 may include multiple on-premise gateways at different customer tenant sites. Examples of the IT resources 110 hosted in the on-premise gateway 102 may include, but are not limited to, servers, storage devices, network switches, routers, mobile communication devices, desktop computers, portable computers, computing system resource enclosures, data centers, or WLAN access points (some of which are depicted in FIG. 1). The servers may be blade servers, for example. The storage devices may be storage blades or storage arrays, for example. Further, in some examples, the computing system enclosures may be a blade enclosure housing one or more blades (e.g., blade servers, storage blades, etc.). One or more of the IT resources 110 may receive packages (e.g., packages 114) and/or package management platforms (e.g., a container management platform 112) to run thereon. Such packages running on the IT resources 110 of the on-premise gateway 102 are also alternatively referred to as on-premise applications hosted by the on-premise gateway 102. Further, in some examples, package management platforms running on the IT resources 110 of the on-premise network 102 are hereinafter referred to as on-premise package management platforms. Also, data stored in the one or more of the IT resources 110 (e.g., storage devices and data centers) is hereinafter referred as an on-premise data. Moreover, services offered by the on-premise applications/packages are hereinafter referred to as on-premise services.

In some examples, the on-premise gateway 102 may either be managed by the tenant on whose premises or colocation the on-premise gateway 102 is located and/or a third-party via a management platform such as the SaaS cloud platform 104. In particular, the management and/or consumption of the IT resources 110, the on-premise package management platforms, the on-premise packages, the on-premise data, and the on-premise services may be performed by authorized tenants of the SaaS cloud platform 104 and facilitated in a cloud-like manner via the SaaS cloud platform 104 and the on-premise gateway 102. In some examples, the SaaS cloud platform 104 may enable management and/or consumption of such capabilities of the on-premise gateway 102 as-a-service in a pay-per-use model at the edge, in colocations, or in a data center. Using the SaaS cloud platform 104, users of a tenant can use the on-premise applications hosted on the on-premise gateway 102, rapidly deploy the on-premise services, gain cost and compliance insights, and simplify management across of IT infrastructure of the on-premise gateway 102. Various examples of the on-premise services and/or public cloud services managed by the SaaS cloud platform 104, in the pay-per-use model, may include, but are not limited to, containers, virtual machines, or bare metal to perform computational tasks; machine learning operations; database platforms such as SAP HANA® produced by SAP SE, data protection, private cloud (including, e.g., networking, storage, or compute resources), and high-performance compute. A user may run various workloads using the foregoing example services.

In the example implementation of the on-premise gateway 102 depicted in FIG. 1, the on-premise gateway 102 is shown to host a package management platform, for example, a container management platform 112. In some examples, the container management platform 112 and/or services offered by on-premise packages running on the container management platform 112 may be used by an authorized user as a service in a pay-per-use model. The container management platform 112 may provide flexibility to deploy and manage containerized applications at scale on any infrastructure, for example, on one or more of the IT resources 110, colocation facilities, multiple public clouds, and at the edge. Further, an authorized user of the container management platform 112 can run cloud-native or non-cloud-native applications in containers without costly refactoring, manage multiple container clusters with a unified control plane, and leverage a high-performance distributed file system for persistent data and stateful applications as a service via the SaaS cloud platform 104 in a pay-per-use model. In an example the container management platform 112 may include a Kubernetes orchestration system.

As depicted in FIG. 1, the on-premise gateway 102 includes an update management system 118 which can interact with the repositories 130 and the configuration management system 132 to control version updates for the on-premise packages (such as the packages 114) hosted on the on-premise gateway 102. The update management system 118 may access released updated versions of the applications from the repositories 130 to deploy the updates in the on-premise gateway 102.

The on-premise packages 114 may represent software that may be managed as containerized applications via the container management platform 112. It is to be noted that the present disclosure is not limited to types of the on-premise packages 114, a use of the on-premise packages 114, functionalities, and/or services offered by the on-premise packages 114. For the purpose of illustration, the on-premise packages 114 are described to include a container package 114-1, a virtual machine (VM) package 114-2, a machine learning (ML) package 114-3, and a data protection package 114-4. Different implementations may include more or fewer on-premise packages or different types of on-premise packages than illustrated in FIG. 1. The on-premise packages 114 may include other packages such as a High Performance Computing (HPC) packages, as an example. Each of the on-premise packages 114 can be used by an authorized user in a pay-per-use model. By way of example, the container package 114-1, the VM package 114-2, the ML package 114-3, and the data protection package 114-4 may allow the authorized user of the container management platform 112 to perform, respectively, various container-based operations, VM vending operations, ML operations (including, but not limited to, building, training, deploying, monitoring of one or more ML models), and data protection operations.

Typically, each of the on-premise packages 114, hereinafter also referred to as package(s) 114, may include a plurality of service components. A service component may be a virtualized or a containerized service and may include source code, dependencies, sub-components, etc. which provides capabilities to a package 114 to perform its operations. The plurality of service components is managed and updated by a plurality of different service teams. Thus, version and configuration information of each of the service components and packages 114 hosted on the on-premise gateway 102 are to be maintained. Each of the service teams managing the service components may release updates, new versions, deploy changes, add sub-components, deliver patches, bug fixes, etc., to the service components at different times based on their respective code development and release cycles. Also, the changes, updates, etc. released by the service teams are may be deployed in the on-premise gateway 102 by installing the changes and/or updates etc. within a maintenance window agreeable to a tenant. Further, for each of the on-premise gateways, such as the on-premise gateway 102, commissioned at a tenant location, the current version and configuration of the packages and its service components deployed at each tenant location are subject to maintenance. Moreover, there may be different versions and configurations for the same packages hosted on different on-premise gateways as per the customer requirements at different tenant locations. Thus, in traditional implementations, controlling service component versioning for updates released by different service teams, managing multiple configurations for multiple hosted packages deployed at different tenant locations, version management for the deployed service components, and automated updates for the on-premise packages hosted at on-premise gateways at different tenant locations may be challenging and difficult to maintain.

Therefore, in accordance with the aspects of the present disclosure, a configuration management system 132 and an update management system 118 is presented that may interact with the repositories 130 and facilitate configuration and version management of different on-premise packages 114 hosted by the on-premise gateway 102 to provide automated updates to the on-premise packages 114 with reduced manual intervention and improved efficiency. In some examples, the use of the configuration management system 132 may allow the version and configuration management to be governed centrally using a standard mechanism. In particular, the configuration management system 132 and the update management system 118 may act in combination with the repositories 130 to enable automatic zero touch updates with reduced manual intervention and without need of altering the on-premise packages (e.g., the on-premise packages 114).

In some examples, a developer (such as the developer 120) may submit a change to a service component of a plurality of service components. The developer may be from one of a plurality of service teams managing the plurality of service components. The service component may be included in a package that is among a plurality of packages (such as the on-premise packages 114) hosted on an on-premise gateway (e.g. on-premise gateway 102) for managing as-a-service workloads. In an example, the developer 120 may submit a pull request (PR) for a service component. In an example, the PR refers to a request to review a change (such as hotfixes, patches, updates) in a service component pushed to a branch of a repository before the change is merged or updated in other branches in the repository. A branch refers to a version of a repository, or in other words, an independent line of development. A repository can contain multiple branches, which means there are multiple versions of the repository. The change to the service component may be submitted in a repository among a plurality of repositories (e.g. repositories 130). A repository name of each of the plurality of repositories 130 is indicative of the package and an environment information of the package. In an example, the environment information may be indicative of different branches or versions of a repository, such as an integration environment, a production environment, a deployment environment, or the like. For example, the repository name of a repository associated with a package providing virtual machine as a service (VMaaS) which include virtual machine vending, management, and deployment solutions, may be “vmaas-integ-config”, where <vmaas> indicates the package associated with the repository and <integ> indicates integration environment which is the environment information. Thus, a repository name may be maintained for each of the repositories 130 using a standard naming format for processing by a DevOps-based system. The standard naming format may be in the form of <package>-<environment information>-<config>.

In some examples, a latest version information of the package may be stored in the repository associated with the package. The latest version information indicates a current version of the package that is released for consumption by the on-premise packages 114 (such as the on-premise VM package 114-2). The latest version information may be stored in a version file that includes updated version information of each of the service components included in the package. In an example, an installed version information of the package for each of the tenants subscribing to the package is stored in the repositories 130. The installed version information of the package for a tenant represents the version information of the package as deployed for the particular tenant.

The configuration management system 132 may determine availability of an updated version of a package for each tenant among a plurality of tenants subscribing to the package. The availability is determined based on the latest version information of the package, the installed version information of the package for the tenant, and an environment information stored in the repositories 130. In an example, the configuration management system 132 may compare the installed version information of the tenant with the latest version information of the package. Based on the comparison, the configuration management system 132 may identify a version drift of the package for the tenant 1. The version drift indicates the availability of the updated version of the package for the tenant. The version drift may include version information of a change in a service component or a change in a service sub-component of the package. In response to determining that an updated version of the package is available for the tenant, the configuration management system 132 publishes the updated version of the package for the tenant to be installed on the on-premise gateway 102. Further, the configuration management system 132 sends a notification indicative of availability of the updated version to the on-premise gateway 102.

The update management system 118 in the on-premise gateway 102 may receive the notification indicative of availability of the updated version of the package for the tenant. The update management system 118 installs the updated version of the package for the tenant in the on-premise gateway 102. In response to successful installation of the updated version, the installed version information of the package for the tenant is updated by the update management system 118. In an example, the installed version information is stored in a deployment phase repository of the tenant associated with the package. The deployment phase repository may be included in the repositories 130. A repository name of the deployment phase repository is indicative of the package, a tenant ID, and a tenant location of the tenant. More details regarding the operations performed in the networked system for updating packages hosted on an on-premise gateway, are illustrated in the following figures, in accordance with an example.

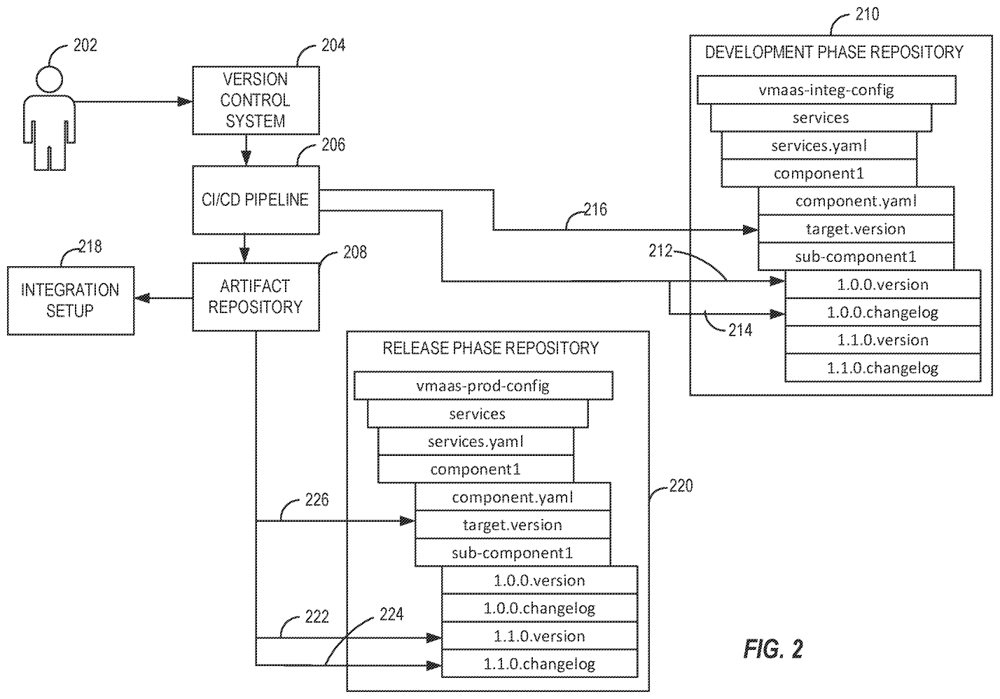

FIG. 2 depicts operations for maintaining versioning of service components in a repository, in accordance with an example. As depicted in FIG. 2, a developer 202, from a service team may submit a PR including a change in a service component. For example, consider that a patch has been developed for a service component “component1” included in a Virtual Machine as a service (VMaaS) package which may be hosted in an on-premise gateway, such as the on-premise gateway 102 of FIG. 1. The change may be submitted to a version control system 204, such as GitHub repository (provided by GitHub, Inc.).

In response to submitting the change in the version control system 204, a Continuous Integration/Continuous Delivery (CI/CD) pipeline 206 is triggered. In an example, the CI/CD pipeline 206 may be available in a cloud-based implementation as Infrastructure as a service (IaaS). In an example, CI-based instructions may be executed to run checks/validation scripts on the change based on the rules defined for the CI/CD pipeline.

Once the change is validated, the CI/CD pipeline may publish an artifact associated with the change in a repository, such as the artifact repository 208. Artifacts are outcomes arising from build processes of instructions, such as source code. Source code compiled for testing may be referred to as an artifact. In an example, the artifact repository 208 may be a binary repository manager which stores binary artifacts along with the metadata in a defined directory structure, which may be conceptually similar to a source code repository. The metadata describes the binary software artifact and includes information such as dependencies, versioning, and build promotions.

After the artifact is published in the artifact repository 208, the CI/CD pipeline may be configured to update version information of the service component in the repositories (e.g. repositories 130 of FIG. 1). Because the change is in a development phase, the version information may be updated in a development phase repository 210 associated with the VMaaS package. The development phase repository 210 has a repository name “vmaas-integ-config”, where the repository name indicates the package VMaaS is associated with the repository and that the updated version of the package is in an “integ” or “integration” environment. Thus, a standard naming format for the development phase repository 208 is “<package name>-<environment information>-config”. Based on the standard naming format, the different service teams can maintain different development phase repositories associated with different packages while following a common framework of naming the repositories for processing by a DevOps-based system. An example structure of a development phase repository is shown below.

“vmaas-integ-config
services
services.yaml
component 1
   component.yaml
   target.version
   sub-component)
      1.0.0.verison
      1.0.0.changelog
   sub-component2
      1.0.0.version
      1.0.0.changelog
   sub-component3
      1.0.0.version
      1.0.0.changelog
component2
component3
coomponent4
dependencies.yaml
   service group1-prod-config
   service group2-prod-config”

The exemplary development phase repository, as shown above, is maintained for a VMaaS package and is in a production environment, as indicated in the repository name. One can compose repositories associated with packages for container or machine learning operations (MLOps) services or any other package in a similar manner. As depicted above, the development phase repository includes a service configuration file indicative of the plurality of service components included in the package. The “services.yaml” is the service configuration file that captures the list of all the service components which are part of the VMaaS package. In an example, service component folders are maintained with service-name, such as “component1”, as the folder name for each service component. The development phase repository includes a service sub-component configuration file indicative of a list of service sub-components included in the package. The “components.yaml” is the service sub-component configuration file under the service component folder and is used to maintain the version of service sub-components. The “target.verson” file is used to manage the latest version of all the service sub-components. Service sub-component folders, such as “sub-component1”, “sub-component2”, and “sub-component3”, as shown above, are maintained with service sub-component name as the folder name for each service sub-component. Version files (e.g.: 1.0.0.version) under each service sub-component folder is used to maintain the version information of the service sub-component. Changelog files (e.g.: 1.0.0.changelog) under each service sub-component folder is used to manage a log of changes to each versions of the service sub-component. The “dependencies.yaml” file indicates a list of service dependencies for the package. Thus, as shown above, the VMaaS package is dependent on two other service groups, such as “service group1” and “service group2”. The service groups may include one or more service components, service sub-components, and packages. Although, the above structure of maintaining the development phase repository is explained with reference to a VMaaS package, in some examples, a similar structure may be used to maintain development phase repositories for other service components and packages.

The change in the service component includes a change in a service sub-component. In the example of FIG. 2, the change is made in a service sub-component “sub-component1” included in the service component “component1”. In an example, updating version information of the service component “component1” in the development phase repository 208 includes updating the version file for service sub-component “subcomponent1” from “1.0.0.version” to “1.1.0.version”, as shown by arrow 212, and updating the changelog file for service sub-component “sub-component1” from “1.0.0.changelog” to “1.1.0.changelog”, as shown by arrow 214.

The CI/CD pipeline 206 may be further configured to update the “target.version” file in the development phase repository 210, as depicted by arrow 216. The “target.version” file reflects a latest version information of the package, VMaaS in this example. The latest version information of the package may correspond to the change in the service component (e.g. “component1”) and may capture version information of a latest version of the package which is in the development phase. The CI/CD pipeline 206 may then be configured to run CD-based instructions to check and validate the latest version as indicated by the latest version information of the package. The integration setup 218 may enable validation of the latest version of the package as indicated by the “target.version” file. The integration setup 218 may run a set of specific tests to ensure that the latest version of the package as indicated in the “target.verison” file is ready for release.

In response to determining that the latest version of the package is not successfully validated in the integration setup 218, further tests may be carried out or the change may be reverted to the service team/developer 202 issuing the change. In response to successful validation of the latest version, a release phase repository 220 associated with the package (for example VMaaS) is updated. The release phase repository 220 stores version information associated with the package in the release or production environment. As indicated by a repository name of the release phase repository 220, <vmaas-prod-config>, the environment information is a production environment, i.e., the change in the service component is ready for release to tenants. In an example, the release phase repository 220 may be a branch of the development phase repository 210.

In an example, updating the version information of the service component “component1” in the release phase repository 220 includes updating the version file for service sub-component “subcomponent1” from “1.0.0.version” to “1.1.0.version” and updating the changelog file for service sub-component “sub-component1” from “1.0.0.changelog” to “1.1.0.changelog”, as depicted by arrows 222 and 224, respectively. Further, the “target.version” file in the release phase repository 220 may be updated to reflect the latest version information of the package as released. Thus, the release phase repository 220 includes an updated version of the package based on tests managed by the CI/CD pipeline. The updated version of the package corresponds to the change in a service component, such as the service component “component1” as depicted in FIG. 2. In an example, the development phase repository 210 and the release phase repository may be included in the repositories 130 of FIG. 1

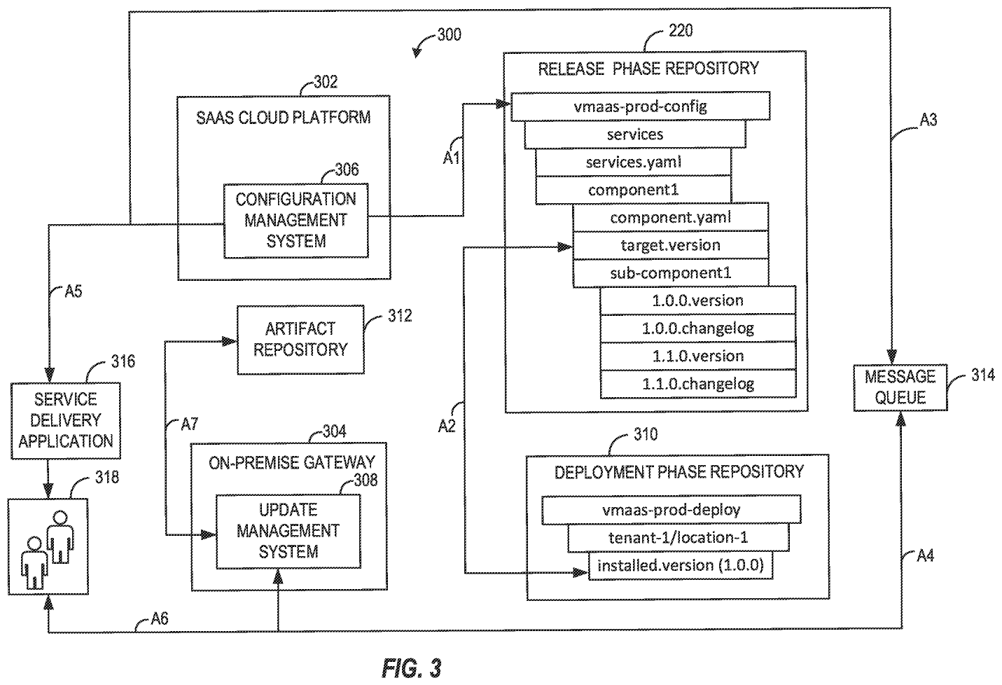

FIG. 3 depicts a networked system 300 for updating a package hosted on an on-premise gateway for managing as-a-service workloads, in accordance with an example. The networked system 300 includes a SaaS cloud platform 302 and an on-premise gateway 304. The SaaS cloud platform 302 may be similar to the SaaS cloud platform 104 and the on-premise gateway 304 may be similar to the on-premise gateway 102. The SaaS cloud platform 302 includes configuration management system 306 that may be similar to configuration management system 130 and the on-premise gateway 304 includes an update management system 308 that may be similar to update management system 118. Further, the networked system 300 includes an artifact repository 312 that may be similar to the artifact repository 208.

The networked system 300 includes repositories (e.g., the repositories 130 of FIG. 1). The repositories may include the release phase repository 220 and a deployment phase repository 310 associated with a specific tenant. For each package commissioned on an on-premise gateway, such as on-premise gateway 304 at a tenant location, installed version and configuration information of service components deployed at each tenant location is maintained in a deployment phase repository. For each package subscribed by a particular tenant, a separate deployment phase repository associated with the package may be maintained which has a naming format “<package>-<environment information>-deploy”. This deployment phase repository associated with the package may capture version information of service components for a particular tenant for a package and environment. Below is an example structure of the deployment phase repository that is maintained to capture tenant specific version information of the packages.

“Tenant 1 [$tenant1Name-$tenant1Id]
[$location]
   installed.version
      service group1-prod-config
      vmaas-prod-config
      policy.json
         Tenant 2 [$tenant2Name-$tenant2Id]
[$location]
   installed.version
      service groupt1-prod-config
      vmaas-prod-config
   policy.json”

In the above example, a structure of deployment phase repository for two tenants, viz. tenant1 and tenant2 are illustrated. Each tenant has a unique tenant Name and tenant ID which may be centrally maintained in the SaaS cloud platform 302. Also, a tenant can have multiple subscriptions each of which may be identified by distinct “$location” name, as indicated in the name of the deployment phase repository. Thus, for a package specific to a tenant for a specific location, a deployment phase repository may be maintained. The “installed.verson” file under the “$location” folder is used to manage the installed version of all the service components included in the package, such as VMaaS. Further, package specific defined data, such as infrastructure inventory with configuration details, applications specific details etc., may be maintained in the deployment phase repository which can be leveraged at time of update/upgrade of service components. Service sub-component folders are named with corresponding service sub-component names. Policies relating to updating the service components included in the package may be managed through the “policy.json” file in the deployment phase repository. The “policy.json” file captures update and upgrade policies for each service component in the package. In an example, the “policy.json” file may specify whether a service component is set or configured for auto update or manual update. The above structure of the deployment phase repository provides the flexibility for the service teams to independently deliver the updates in a DevOps-based model.

The configuration management system 306 may periodically determine availability of an updated version of a package for each tenant among a plurality of tenants subscribing to the package. Consider that the configuration management system 306 determines availability of an updated version of a VMaaS package. In an example, the configuration management system 306 may determine availability of a package for other services, such as containers as a service, MLOps as a service, etc., or any other packages 114 as hosted by the on-premise gateway 304.

In an example, the configuration management system 306 may connect to a release phase repository, such as the release phase repository 220, associated with a package, for example VMaaS, as shown by arrow “A1”. The configuration management system 306 may check for an updated version of the package based on a latest version information of the package as captured in the “target.version” file maintained in the release phase repository 220. The “target.verson” file is used to manage the latest version of all the service sub-components included in the VMaaS package as depicted in FIG. 3. Thus, a change in a service component, which may arise from a change in a service sub-component included in the service component, may be reflected in the “target.version” file maintained in the release phase repository 220 associated with the VMaaS package.

The configuration management system 306 identifies a deployment phase repository of a tenant associated with the package. For example, the configuration management system 306 may identify that “tenant1” at “location1” subscribes to the VMaaS package. Thus, deployment phase repository 310 shall include installed version information of the VMaaS package for “tenant1” at “location1”. As may be understood, a repository name of the deployment phase repository indicates the package (VMaaS in this example), a tenant ID, and a tenant location of the tenant1. The installed version information of the package is stored in the deployment phase repository 310. As shown in FIG. 3, the installed version of the package VMaaS for tenant-1/location-1 is 1.0.0.

The configuration management system 306 compares the installed version information of the tenant (tenant-1/location-1 in this example) with the latest version information of the package as captured in the “target.version” file in the release phase repository 220, as shown by arrow A2. Based on the comparison, the configuration management system 306 may identify a version drift of the package (VMaaS) for the tenant-1 at location-1. The version drift indicates the availability of the updated version of the package for the tenant1. The version drift may include version information of a change in a service component or a change in a service sub-component. For example, in the release phase repository 220, the version drift may include “1.1.0.version” and “1.1.0.changelog” for the service sub-component “glcg-cmp-node-image”. Thus, in an example, the version drift indicates change in version information and changelog information included in a service sub-component folder in the release phase repository as compared to the version and changelog information in an installed version for a particular tenant in a deployment phase repository.

Thus, in response to determining availability of an updated version of the package, the configuration management system 306 may publish the updated version of the package for the tenant1 to be installed on the on-premise gateway 304. In an example, publishing the updated version of the package for installation in the on-premise gateway 304 includes making an artifact associated with the updated version of the package stored in the artifact repository 312 available to an update management system 308 in the on-premise gateway 304.

Further, the configuration management system 306 may send a notification indicative of availability of the updated version of the package to the on-premise gateway 304. In an example, the configuration management system 306 may determine whether the service component is set to auto update or manual update based on a policy information of the service component. The configuration management system 306 may check the “policy.json” file in a deployment phase repository, such as the deployment phase repository 310, to determine the policy information of the service component. The policy information may specify whether a service component/service sub-component included in the package is set to manual update or auto update.

Manual update refers to an update process for a package which is managed by a service team based on outcomes from the configuration management system 306. In a manual update, a service team responsible for the update may fetch artifacts associated with an updated version of the package from the artifact repository 312 and install the updated version of the package in the on-premise gateway based on inputs from the service team.

Auto update refers to an update process for a package which is managed by the update management system 308 based on outcomes from the configuration management system 306. In an auto update, the update management system 308 may fetch artifacts associated with the updated version of the package from the artifact repository 312 and install the updated version of the package in the on-premise gateway 304 based on outcomes of the configuration management system 306.

In response to determining that the service component is set to auto update, the configuration management system 306 may send a notification indicating availability of the updated version to a notification service message queue 314 in communication with the on-premise gateway 304, as shown by arrow A3. In an example, the message queue 314 is a distributed publish-subscribe system, such as Simple Notification Service (SNS). Messages can be pushed to subscribers as and when they are sent by publishers to the message queue. The update management system 308 in the on-premise gateway 304 may be logged in as a subscriber to the message queue 314 and thus may access notifications, as shown by arrow A4, pushed to the message queue 314 by a publisher, such as the configuration management system 306. In an example, for containerized services, a cloud-native CD process (such as GitOps) may be invoked that may synchronize the installed version on the respective tenant locations with the latest version of the package available for consumption. For example, Argo CD may be used with Kubernetes-based deployments to synchronize the installed version with the latest version as part of the cloud-native CD process.

In response to determining that the service component is set to manual update, the configuration management system 306 may send the notification to a service delivery application 316, as shown by arrow A5, monitored by a service team 318 that issued the change. In an example, the service delivery application 316 may be a ticketing tool that allows the service team 318 to be informed about the availability of the updated version of the package. In an example, in response to determining that the updated version is available, the configuration management system 306 may send the notification which may in turn raise a ticket in the service delivery application. The ticket may be visible to the service team 318.

The update management system 308 may receive the notification indicating availability of the updated version of the package from the message queue 314, as shown by arrow A4. Alternatively, the update management system 308 may also receive an input from the service team 318 as shown by arrow A6, where the input indicates a command to process and install the updated version of the package.

The update management system 308 may fetch, based on the notification, the updated version of the package from a release phase repository, such as the release phase repository 220 associated with the package. The updated version of the package is fetched by processing a notification received from a notification service message queue, such as the message queue 314.

The update management system 308 may install, based on the notification, the updated version of the package for the tenant. In an example, the update management system 308 may identify artifacts associated with the updated version of the package from the artifact repository 312, as shown by arrow A7. In an example, the artifacts may be installed in the package (e.g. VMaaS) hosted on the on-premise gateway 304 thereby deploying the updated version of the package. In response to successful installation of the updated version of the package in the on-premise gateway 304, an installed version information of the package is updated for the tenant. In an example, the installed version information is stored in the “installed.version” file in a deployment phase repository, such as the deployment phase repository 310, of the tenant (for e.g. tenant1) associated with the package (e.g. VMaaS). Updating the installed version information of the package may include changing the information in the “installed.version” file from “installed.version(1.0.0)” to “installed.version(1.1.0)”. In response to a failure in successfully installing the updated version of the package, the update management system 308 may trigger a rollback of the update for the service component. The rollback may include withdrawal of changes to the service component that may have occurred as the installation of the updated version of the package had been initiated. Thus, the configuration management system 306 and update management system 308 may efficiently enable update of service components/service sub-components included in a package with reduced manual effort and facilitate deployment of changes submitted by different service teams at different stages of development in an on-premise gateway of a tenant subscribing to the package.

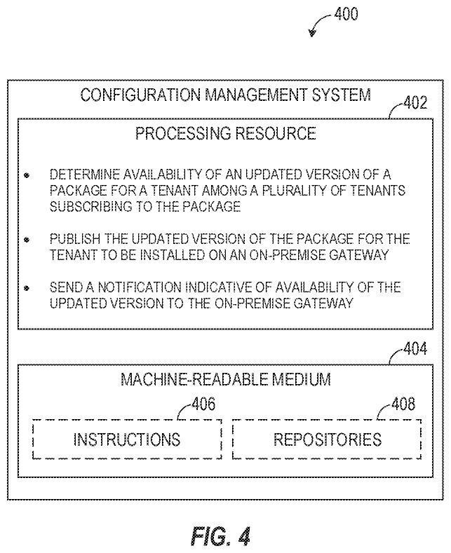

FIG. 4 depicts a configuration management system 400 hosted in a SaaS cloud platform, in accordance with an example. In some examples, the configuration management system 400 may be a processor-based system that performs various operations intended to manage updates to packages hosted on an on-premise gateway, such as the on-premise gateway 102 of FIG. 1. In an example, the configuration management system 400 is similar to the configuration management system 132 hosted in the SaaS cloud platform 104 of FIG. 1.

As depicted in FIG. 4, in some examples, the configuration management system 400 may include a processor or microcontroller and/or any other electronic component, or a device or system that may facilitate various compute, data storage, and/or data processing, for example. Further, in certain examples, the configuration management system 400 may be a virtual machine or a containerized package executing on one or more of IT resources in the SaaS cloud platform. In some examples, the configuration management system 400 may be deployed outside the SaaS cloud platform, without limiting the scope of the present disclosure.

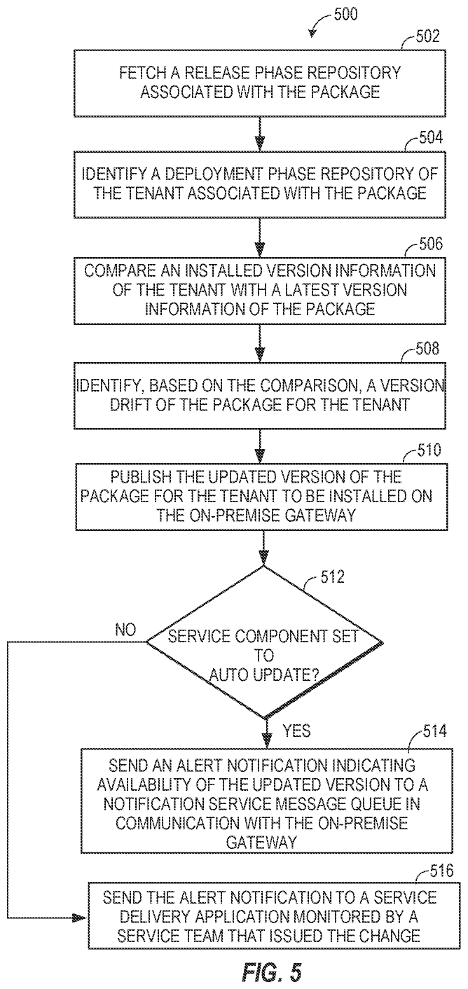

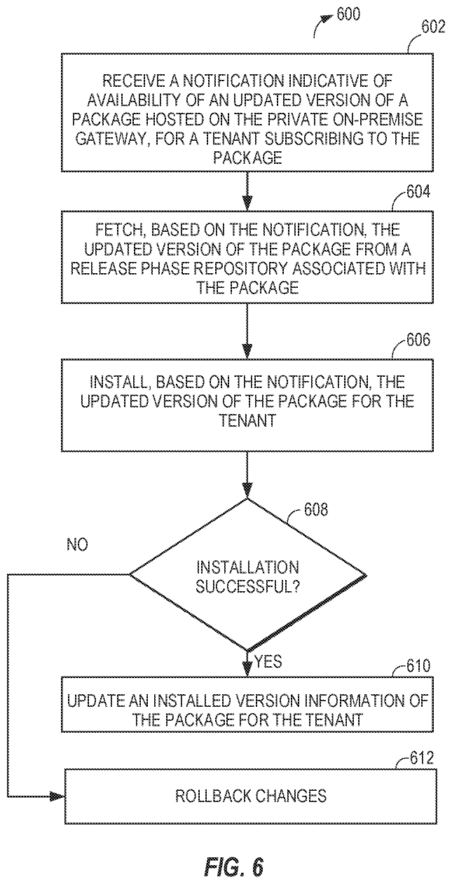

The configuration management system 400 includes a processing resource 402 and a machine-readable medium 404. The machine-readable medium 404 may be any electronic, magnetic, optical, or other physical storage device that may store data and/or executable instructions 406. For example, the machine-readable medium 404 may include one or more of a Random Access Memory (RAM), an Electrically Erasable Programmable Read-Only Memory (EEPROM), a storage drive, a flash memory, a Compact Disc Read Only Memory (CD-ROM), and the like. The machine-readable medium 404 may be non-transitory. As described in detail herein, the machine-readable medium 404 may be encoded with the executable instructions 406 to perform one or more methods, for example, methods described with reference to FIGS. 5-6 described below.

Further, the processing resource 402 may be a physical device, for example, one or more central processing unit (CPU), one or more semiconductor-based microprocessors, one or more graphics processing unit (GPU), application-specific integrated circuit (ASIC), a field programmable gate array (FPGA), other hardware devices capable of retrieving and executing instructions 406 stored in the machine-readable medium 304, or combinations thereof. The processing resource 402 may fetch, decode, and execute the instructions 406 stored in the machine-readable medium 404 to manage update of a package hosted in an on-premise gateway. As an alternative or in addition to executing the instructions 406, the processing resource 402 may include at least one integrated circuit (IC), control logic, electronic circuits, or combinations thereof that include a number of electronic components for performing the functionalities intended to be performed by the configuration management system 400. Moreover, in certain examples, where the configuration management system 400 is implemented as a virtual machine or a containerized application, the processing resource 402 and the machine-readable medium 404 may represent a processing resource and a machine-readable medium of a hardware or a computing system that hosts the configuration management system 400 as the virtual machine or the containerized application.

In some examples, a service team for a service component included in a package may release an update for a package deployed in an on-premise gateway, such as the on-premise gateway 102 of FIG. 1. The processing resource 402 may execute one or more of the instructions 406 to determine availability of an updated version of the package for each tenant among a plurality of tenants subscribing to the package, where the package includes a plurality service components. In an example, the package is among a plurality of packages hosted on an on-premise gateway for managing as-a-service workloads. The updated version corresponds to a change to at least one of the plurality of service components. In an example, a change in a service component may include a change in a service sub-component included in the service component. The change is received from at least one of a plurality of different service teams managing the plurality of service components. The determination is based on a latest version information of the package, an installed version information of the package for the tenant, and an environment information stored in a plurality of repositories 408, each of the plurality of repositories being identified by a repository name indicative of the package and the environment information. In some examples, the repositories 408 may include a development phase repository 210, a release phase repository 220, and a deployment phase repository 310 as shown in FIGS. 2 and 3. Although, the repositories 408 are shown to be included within the machine-readable medium 404, in an example, the repositories 408 may be part of a storage medium separate from the machine-readable medium 408.

Further, the processing resource 402 may execute one or more of the instructions 406 to publish the updated version of the package for the tenant to be installed on the on-premise gateway, such as the on-premise gateway 102 of FIG. 1. The processing resource 402 may further execute one or more of the instructions 406 to send a notification indicative of availability of the updated version to the on-premise gateway. More details regarding the operations performed by the processing resource 402 by executing one or more of the instructions 406 for updates to a package are described in conjunction with methods of FIGS. 5-6.

FIG. 5 illustrates a flow diagram depicting a method 500 for updating a package hosted on an on-premise gateway for managing as a service workloads, according to an example. For illustration purposes, the method 500 will be described in conjunction with the networked system 100 of FIG. 1. The method 500 may include method blocks 502, 504, 506, 508, 510, 512, 514, and 516 (hereinafter collectively referred to as blocks 502-516), which may be performed by a processor-based system such as, for example, the configuration management system 130 or 306. In particular, operations at the method blocks 502-516 may be performed by the processing resource 402 of the configuration management system 400 by executing the instructions 406 stored in the machine-readable medium 404. Moreover, it is to be noted that in some examples, the order of execution of the blocks 502-516 may be different from the one shown in FIG. 5. For example, the blocks 502-516 may be performed in series, in parallel, or a series-parallel combination.

Consider that an updated version of a package (e.g. VMaaS) is available in a release phase repository, such as the release phase repository 220 in FIG. 2. For example, the updated version of the package may correspond to a change in a service sub-component “glcg-cmp-node-image” of a service component “glcg-cmp” included in the VMaaS package, also illustrated in FIG. 2. In an example, a latest version information of the package may be stored in a “target.version” file in the release phase repository 220, as illustrated in FIG. 2. In an example, the change is validated based on tests managed by a CI/CD model, prior to updating the latest version information in the release phase repository.

At block 502, the processing resource 402 of the configuration management system 400 may connect to a release phase repository, such as the release phase repository 220 associated with a package, such as the VMaaS package. At block 504, the processing resource 402 of the configuration management system 400 may identify, a deployment phase repository of the tenant associated with the package, such as the deployment phase repository 310 of the tenant1 associated with the package VMaaS, as depicted in FIG. 3. A repository name of the deployment phase repository may indicate the package, a tenant ID, and a tenant location of the tenant. An installed version information of the service component, i.e. the service component “glcg-cmp” for which the change was released (as described in FIG. 2) is stored in the deployment phase repository 310 for the tenant1.

At block 506, the processing resource 402 of the configuration management system 400 may compare the installed version information of the tenant with the latest version information of the package. The latest version information of the package may be stored in the release phase repository, such as the release phase repository 220 of FIG. 2. If the installed version information is different from the latest version information, a difference between the installed version and the latest version may be calculated as a version drift. Thus, based on the comparison, the version drift may be identified at block 508. The version drift is indicative of the availability of the updated version of the package for the tenant1. The version drift may include version information of a change in a service component or a change in a service sub-component. For example, in the release phase repository 220, the version drift may include “1.1.0.version” and “1.1.0.changelog” for the service sub-component “glcg-cmp-node-image”. Thus, in an example, the version drift indicates change in version information and changelog information included in a service sub-component folder in the release phase repository as compared to the version and changelog information in an installed version for a particular tenant in a deployment phase repository. The version drift indicates that an updated version of the package is available.

At block 510, the updated version of the package for the tenant that is to be installed on the on-premise gateway is published. In an example, publishing the updated version of the package for installation in the on-premise gateway 304 includes making an artifact associated with the updated version of the package stored in an artifact repository (e.g., 208 or 312), available to an update management system (e.g. 308).

At block 512, the processing resource 402 of the configuration management system 400 may determine whether the service component is set to auto update. In an example, the determination may be performed based on a policy information of the service component as mentioned in a “policy.json” file included in a deployment phase repository, such as the deployment phase repository 310.

In response to determining that the service component is set to auto update (Yes' branch from block 512), at block 514, the processing resource 402 of the configuration management system 400 may send an alert notification indicating availability of the updated version to a notification service message queue, such as the message queue 314 of FIG. 3, in communication with the on-premise gateway, such as the on-premise gateway 304. An update management system in the on-premise gateway may read the notifications in the message queue and process the notifications to install the updated version of the package in the on-premise gateway. At block 516, in response to determining that the service component is set to manual update, the processing resource 402 of the configuration management system 400 may send the alert notification to a service delivery application, such as a ticketing tool, monitored by a service team that issued the change. Based on a ticket raised in the service delivery application, the service team may process the notification and initiate installation of the updated version of the package in the on-premise gateway. Thus, an updated version of the package may be deployed in the on-premise gateway.

FIG. 6 illustrates a flow diagram depicting a method 600 for updating a package hosted on an on-premise gateway for managing as a service workloads, according to an example. For illustration purposes, the method 600 will be described in conjunction with the networked system 100 of FIG. 1 and the networked system 300 of FIG. 3. The method 600 may include method blocks 602, 604, 606, 608, 610, and 612 (hereinafter collectively referred to as blocks 602-612), which may be performed by a processor-based system, for example, the update management system 118 or 308. In particular, operations at the method blocks 602-612 may be performed by a processing resource of the update management system 308 by executing instructions stored in a machine-readable medium. Moreover, it is to be noted that in some examples, the order of execution of the blocks 602-612 may be different from the one shown in FIG. 6. For example, the blocks 602-612 may be performed in series, in parallel, or a series-parallel combination.

Referring to FIG. 6, at block 602, the update management system may receive a notification indicating availability of an updated version of a package hosted on the private on-premise gateway, for a tenant subscribing to the package. In an example, a configuration management system, such as the configuration management system 306, may issue the notification to a message queue, such as the message queue 314.

At block 604, the update management system 308 may fetch, based on the notification, the updated version of the package from a release phase repository associated with the package, such as the release phase repository 220 associated with the package VMaaS. In an example, the notification may include an indication of availability of the updated version for a specific package. Thus, the updated version of the package may be fetched by processing the notification which may be received from a notification service message queue, such as the message queue 318 of FIG. 3.

At block 606, the update management system 308 may install, the updated version of the package for the tenant based on processing the notification. At block 608, it may be checked whether the updated version is successfully installed in the on-premise gateway. At block 610, in response to successful installation of the updated version (“yes” branch from block 608), an installed version information of the package for the tenant may be updated. In an example, the installed version information may be included in a deployment phase repository, such as the deployment phase repository 310 of FIG. 3, of the tenant. A repository name of the deployment phase repository may indicate the package, a tenant ID, and a tenant location of the tenant. At block 612, in response to installation of the updated version being unsuccessful (“No” branch from block 608), the update management system may rollback of applied changes. Rollback may include uninstalling of partially installed or corrupt patches where the update process is not successfully completed.

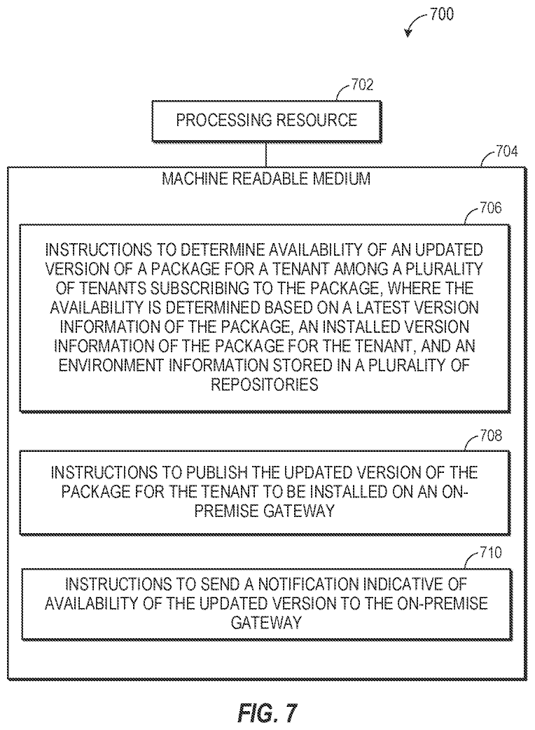

FIG. 7 is a block diagram 700 depicting a processing resource 702 and a machine-readable medium 704 encoded with example instructions to facilitate update of packages hosted in an on-premise gateway for managing as-a-service workloads, in accordance with an example. The machine-readable medium 704 may be non-transitory and is alternatively referred to as a non-transitory machine-readable medium 704. In some examples, the machine-readable medium 704 may be accessed by the processing resource 702. In some examples, the processing resource 702 may represent one example of the processing resource 402 of the configuration management system 400. Further, the machine-readable medium 704 may represent one example of the machine-readable medium 404 of the configuration management system 400.

The machine-readable medium 704 may be any electronic, magnetic, optical, or other physical storage device that may store data and/or executable instructions. Therefore, the machine-readable medium 704 may be, for example, RAM, an EEPROM, a storage drive, a flash memory, a CD-ROM, and the like. As described in detail herein, the machine-readable medium 704 may be encoded with executable instructions 706, 708, and 710 (hereinafter collectively referred to as instructions 706-710) to manage updates of a package hosted on an on-premise gateway, such as the on-premise gateway accessible via a SaaS cloud platform, such as the SaaS cloud platform 104. Although not shown, in some examples, the machine-readable medium 704 may be encoded with certain additional executable instructions to perform the method 500 as described in FIG. 5, and/or any other operations performed by the configuration management system 132 or 306, without limiting the scope of the present disclosure.

The processing resource 702 may be a physical device, for example, one or more CPU, one or more semiconductor-based microprocessor, one or more GPU, ASIC, FPGA, other hardware devices capable of retrieving and executing the instructions 706-710 stored in the machine-readable medium 704, or combinations thereof. In some examples, the processing resource 702 may fetch, decode, and execute the instructions 706-710 stored in the machine-readable medium 704 to manage update of packages hosted in an on-premise gateway for managing as-a-service workloads. In certain examples, as an alternative or in addition to retrieving and executing the instructions 706-710, the processing resource 702 may include at least one integrated circuit, other control logic, other electronic circuits, or combinations thereof that include a number of electronic components for performing the functionalities intended to be performed by the configuration management system 132 or 306.

The instructions 706 when executed by the processing resource 702 may cause the processing resource 702 to determine availability of an updated version of a package for each tenant among a plurality of tenants subscribing to the package. The package may include a plurality of service components, where the package is among a plurality of packages hosted on an on-premise gateway for managing as-a-service workloads. The updated version corresponds to a change to at least one of the plurality of service components, where the change is received from at least one of a plurality of different service teams managing the plurality of service components. In an example, the determination is based on a latest version information of the package, an installed version information of the package for the tenant, and an environment information stored in a plurality of repositories. Each of the plurality of repositories are identified by a repository name indicative of the package and the environment information.

Further, the instructions 708 when executed by the processing resource 702 may cause the processing resource 702 to publish the updated version of the package for the tenant to be installed on the on-premise gateway. Moreover, the instructions 710 when executed by the processing resource 702 may cause the processing resource 702 to send a notification indicative of availability of the updated version to the on-premise gateway.

While certain implementations have been shown and described above, various changes in form and details may be made. For example, some features and/or functions that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described.

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled,” as used herein, is defined as connected, whether directly without any intervening elements or indirectly with at least one intervening element, unless indicated otherwise. For example, two elements can be coupled mechanically, electrically, or communicatively linked through a communication channel, pathway, network, or system. Further, the term “and/or” as used herein refers to and encompasses any and all possible combinations of the associated listed items. It will also be understood that, although the terms first, second, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

In the foregoing description, numerous details are set forth to provide an understanding of the subject matter disclosed herein. However, implementation may be practiced without some or all of these details. Other implementations may include modifications, combinations, and variations from the details discussed above. It is intended that the following claims cover such modifications and variations.

I/We claim:

1. A non-transitory machine-readable medium comprising processor executable instructions, the instructions when executed by a processor, cause the processor:
determine availability of an updated version of a package for a tenant among a plurality of tenants subscribing to the package, wherein the package includes a plurality of service components and the package is among a plurality of packages hosted on an on-premise gateway for managing as-a-service workloads, wherein the updated version corresponds to a change to at least one of the plurality of service components, wherein the change originates from at least one of a plurality of different service teams managing the plurality of service components, and wherein the availability is determined based on a latest version information of the package, an installed version information of the package for the tenant, and an environment information stored in a plurality of repositories, each of the plurality of repositories being identified by a repository name indicative of the package and the environment information;
publish the updated version of the package for the tenant to be installed on the on-premise gateway; and
send a notification indicative of availability of the updated version to the on-premise gateway.

2. The non-transitory machine-readable medium of claim 1, wherein the plurality of repositories includes a development phase repository associated with the package,
wherein a repository name of the development phase repository indicates that the updated version of the package is in an integration environment, and the development phase repository including a version file and a changelog indicative of the change in the service component.

3. The non-transitory machine-readable medium of claim 1, wherein the plurality of repositories includes a release phase repository,
wherein a repository name of the release phase repository indicates that the package is in a production environment, and
wherein the updated version of the package is stored in the release phase repository based on tests managed by a continuous integration/continuous delivery model (CI/CD) model.

4. The non-transitory machine-readable medium of claim 3, wherein the instructions to determine availability of the updated version comprises instructions to:
connect to the release phase repository associated with the package, the release phase repository including the latest version information of the package;
identify a deployment phase repository of the tenant associated with the package, wherein a repository name of the deployment phase repository indicates the package, a tenant ID, and a tenant location of the tenant, and wherein the installed version information of the service component is stored in the deployment phase repository;
compare the installed version information of the tenant with the latest version information of the package; and
identify, based on the comparison, a version drift of the package for the tenant, wherein the version drift is indicative of the availability of the updated version of the package for the tenant.

5. The non-transitory machine-readable medium of claim 3, wherein the change is validated based on tests managed by a CI/CD model prior to updating the latest version information in the release phase repository.

6. The non-transitory machine-readable medium of claim 1, wherein the instructions to send the notification comprises instructions to:
determine whether the service component is set to auto update or manual update based on a policy information of the service component;
in response to determining that the service component is set to auto update, send an alert notification indicating availability of the updated version to a notification service message queue in communication with the on-premise gateway; and
in response to determining that the service component is set to manual update, send the alert notification to a service delivery application monitored by a service team that issued the change.

7. The non-transitory machine-readable medium of claim 1, wherein, in response to successful validation of the change, a set of artifacts associated with the change is published in an artifact repository.

8. The non-transitory machine-readable medium of claim 1, wherein the repository name of each of the plurality of repositories is maintained using a standard naming format for processing by a DevOps-based system.

9. The non-transitory machine-readable medium of claim 1, wherein each of the plurality of repositories includes a service configuration file indicative of the plurality of service components included in the package, a sub-service configuration file indicative of a list of service sub-components included in the package, and a dependency file indicative of a list of service dependencies for the package.

10. The non-transitory machine-readable medium of claim 1, wherein the SaaS cloud platform allows the tenant to access the workloads managed by the on-premise gateway in a pay-per-use model.

11. The non-transitory machine-readable medium of claim 1, wherein the package provides at least one of Virtual Machines as a Service, Containers as a Service, Machine Learning Operations as a Service, Data Protection as a Service, or High Performance Compute as a Service to the tenant.

12. An update management system, comprising:
a processing resource; and
a machine-readable medium storing instructions that, when executed by the processing resource, cause the processing resource to:
receive a notification indicative of availability of an updated version of a package hosted on a private on-premise gateway for a tenant subscribing to the package, wherein the on-premise gateway manages as-a-service workloads;
install, based on the notification, the updated version of the package for the tenant; and
in response to successful installation of the updated version, update an installed version information of the package for the tenant, wherein the installed version information is stored in a deployment phase repository of the tenant associated with the package, a repository name of the deployment phase repository being indicative of the package, a tenant ID, and a tenant location of the tenant.

13. The update management system of claim 12, wherein, the processing resource executes one or more of the instructions to:
fetch, based on the notification, the updated version of the package from a release phase repository associated with the package, wherein the updated version of the package is fetched by processing a notification received from a notification service message queue.

14. The update management system of claim 12, wherein the notification is received from a notification service message queue in communication with the update management system.

15. A method comprising:
determining, by a processor-based system, availability of an updated version of a package for a tenant among a plurality of tenants subscribing to the package, wherein the package includes a plurality service components and the package is among a plurality of packages hosted on an on-premise gateway for managing as-a-service workloads, wherein the updated version corresponds to a change to at least one of the plurality of service components, wherein the change originates from at least one of a plurality of different service teams managing the plurality of service components, and wherein the availability is determined based on a latest version information of the package, an installed version information of the package for the tenant, and an environment information stored in a plurality of repositories, each of the plurality of repositories being identified by a repository name indicative of the package and the environment information;
publishing, by the processor-based system, the updated version of the package for the tenant to be installed on the on-premise gateway; and
sending, by the processor-based system, a notification indicative of availability of the updated version to the on-premise gateway.

16. The method of claim 15, wherein the plurality of repositories includes a development phase repository associated with the package, and
wherein a repository name of the development phase repository indicates that the updated version of the package is in an integration environment, the development phase repository including a version file and a changelog indicative of the change in the service component.

17. The method of claim 15, wherein determining availability of the updated version comprises:
connecting to a release phase repository associated with the package, the release phase repository including the latest version information of the package;
identify a deployment phase repository of the tenant associated with the package, wherein a repository name of the deployment phase repository indicates the package, a tenant ID, and a tenant location of the tenant, and wherein the installed version information of the service component is stored in the deployment phase repository;
compare the installed version information of the tenant with the latest version information of the package; and
identify, based on the comparison, a version drift of the package for the tenant, wherein the version drift is indicative of the availability of the updated version of the package for the tenant.

18. The method of claim 15, wherein sending the notification comprises:
determining whether the service component is set to auto update or manual update based on a policy information of the service component;
in response to determining that the service component is set to auto update, sending an alert notification indicating availability of the updated version to a notification service message queue in communication with the on-premise gateway; and
in response to determining that the service component is set to manual update, sending the alert notification to a service delivery application monitored by a service team that issued the change.

19. The method of claim 15, wherein the plurality of repositories includes a release phase repository,
wherein a repository name of the release phase repository indicates that the package is in a production environment, and
wherein the updated version of the package is stored in the release phase repository based on tests managed by a continuous integration/continuous delivery model (CI/CD) model.

20. The method of claim 15, wherein, in response to successful validation of the change, a set of artifacts associated with the change is published in an artifact repository.
